(19) United States
(12) Patent Application Publication
(10) Pub. No.: US 2021/0116132 A1
(43) Pub. Date: Apr. 22, 2021

(54) METHOD FOR THE OPERATION OF A RADIANT HEATING DEVICE AND COMBINATION OF A RADIANT HEATING DEVICE WITH A ROTARY SWITCH DEVICE

(71) Applicant: E.G.O. Elektro-Geraetebau GmbH, Oberderdingen (DE)

(72) Inventors: Robin Abendschoen, Eppingen (DE); Marcus Frank, Sulzfeld (DE); Mario Funk, Karlsdorf-Neuthard (DE); Matthias Mangler, Karlsbad (DE); Jochen Rickert, Oberderdingen (DE); Sigrid Bader, Sulzfeld (DE)

(21) Appl. No.: 17/026,558

(22) Filed: Sep. 21, 2020

(30) Foreign Application Priority Data
Oct. 17, 2019 (DE) 10 2019 216 020.4

(51) Int. Cl. F24C 7/08; F24C 7/04; H05B 6/06

(52) U.S. Cl. CPC F24C 7/088; H05B 6/065; F24C 7/043

(57) ABSTRACT

A method for the operation of a radiant heating device for a cooktop, which device comprises two separately operable heating elements that are arranged in loops on a carrier and that are individually connectable to a power supply, and comprises a heat maintenance mode, a cooking mode and a boost mode. In the heat maintenance mode, only one heating element, with a single, fixed, relatively low heat maintenance power, is operated. In the cooking mode a different element is operated with adjustable power, and is adjusted between a relatively low minimum cooking power and a relatively high maximum cooking power. In the boost mode, all the heating elements of the radiant heating device are operated, wherein the power of all the heating elements is fixed and not adjustable. The heating element operated in the cooking mode is operated with its maximum power of the cooking mode, and the heating element that is not operated in cooking mode is operated with a power above the heat maintenance power of the heat maintenance mode.

### CROSS-REFERENCE TO RELATED APPLICATIONS

This application claims priority to German Application No. 10 2019 216 020.4, filed Oct. 17, 2019, the contents of which are hereby incorporated herein in its entirety by reference.

### FIELD OF APPLICATION AND PRIOR ART

The invention relates to a method for the operation of a radiant heating device and to a combination of a corresponding radiant heating device with a rotary switch device. Advantageously, the radiant heating device is operated in a cooktop.

A rotary switch device as a controller for a heating device of a cooktop is in general known from U.S. Pat. No. 3,668,593 A1. Different interconnections can be implemented depending on different rotary positions, or in different angular regions.

A radiant heating device for a cooktop that comprises a plurality of separate, long heating elements on a carrier is known from U.S. Pat. No. 9,894,716 B2. These heating elements can operate in different modes, whereby different power ranges can be covered. The different modes or powers can be set by means of a rotary switch device.

### OBJECT AND SOLUTION

The invention is based on the object of creating a method as mentioned at the beginning as well as a combination of a radiant heating device with a rotary switch device with which problems of the prior art can be solved and it is in particular possible to be able to operate a radiant heating device variably and to influence the heating power, preferably to be able to reach a very high maximum power.

This object is achieved by a method with the features of claim 1 and by a combination of a radiant heating device with a rotary switch device having the features of claim 19. Advantageous and preferred embodiments of the invention are the object of the further claims, and are explained in more detail below. Some of the features here are only described for the method or only for the combination. Regardless of this, they can nevertheless apply both for the method and for the combination on their own account and independently of one another. The wording of the claims is made to be content of the description through explicit reference.

It is provided that the method for the operation of a radiant heating device serves for a cooktop. The radiant heating device here comprises at least two separately operable heating elements that are preferably of elongated form, for example according to the aforesaid U.S. Pat. No. 9,894,716 B2. The heating elements are arranged in loops or spirals and/or essentially along concentric circles on a carrier of the radiant heating device. They can be connected individually to a power supply.

The method here comprises a heat maintenance mode, a cooking mode and a boost mode with the radiant heating device, in other words three different types of operating mode. In the heat maintenance mode, not all heating elements are operated, but at least one heating element is operated with a single, fixed, relatively low heat maintenance power. In particular, only precisely one single heating element is operated.

In cooking mode, a heating element is operated with adjustable power, wherein advantageously not all of the heating elements are operated here, but rather at least one, although less than all. The power of the at least one operated heating element is adjusted between a relatively low minimum cooking power and a relatively high maximum cooking power. In boost mode, all the heating elements of the radiant heating device are operated, wherein the power of all the heating elements is fixed and not adjustable. In boost mode, the at least one heating element that is operated in cooking mode, or all of the heating elements that are operated in cooking mode, is/are operated at their maximum power of the cooking mode. The at least one, or all, of the heating elements not operated in cooking mode are operated with at least the heat maintenance power of the heat maintenance mode. Advantageously all of the heating elements not operated in cooking mode are in fact operated with the maximum power possible for them.

In an advantageous embodiment, the heating elements in heat maintenance mode are different from the heating elements in cooking mode. Particularly advantageously, no heating element is operated in heat maintenance mode as well as in cooking mode, but in each case different heating elements are used for the two types of operating mode. A graduation of the power between heat maintenance mode and cooking mode can thus be achieved. Only in boost mode is it advantageous for heating elements to be operated that are also operated in one of the two other modes. Particularly advantageously, all of the heating elements of the radiant heating device are operated in boost mode.

In one embodiment of the invention, in heat maintenance mode the at least one heating element operated in heat maintenance mode is connected to an outer conductor and a center conductor of a star-network power supply. The network power supply comprises at least two outer conductors and a center conductor. A network power supply of this type corresponds to a usual network power supply with, usually, three outer conductors and a center conductor.

Preferably only one single heating element is operated in heat maintenance mode, wherein it is preferably operated in heat maintenance mode with the lowest, or the lowest possible, operating power of the radiant heating device. Particularly preferably, the single heating element is operated with a low power of between 150 W and 300 W.

The relatively low minimum cooking power and the relatively high maximum cooking power can lie between 4% and 90% of the maximum power of the radiant heating device. In particular they lie between 200 W and 4000 W. A boost power is at a higher level; advantageously it can lie between 4000 W and 5000 W, for example at about 4700 W.

Particularly preferably, the at least one heating element operated in cooking mode is connected to two outer conductors of a previously described star-network power supply. A higher voltage can thus be used than with a connection only to one outer conductor and the center conductor.

A different heating element is advantageously operated in cooking mode than the one that is operated in heat maintenance mode. Particularly advantageously, only one single heating element is operated in cooking mode.

In a development of the invention, the total power generated by the radiant heating device in cooking mode can be adjusted or can be set. It can in particular be provided that the power is largely or fully continuously adjustable. This preferably takes place by clocking making use of an actuation duration, as this is known from what are known as energy regulators, as are known from U.S. Pat. No. 6,211,582 B2.

In a development of the invention it can be provided that the power of the radiant heating device can only be adjusted in cooking mode. In heat maintenance mode and in boost mode, on the other hand, the power of the radiant heating device or of the heating elements can be predefined. This can enable simplified operation, since graduation is not necessary in the two modes with very low and very high power. The effort for adjustability or ability to regulate can thus also be saved.

In an embodiment of the invention, all of the heating elements of the radiant heating device are operated in boost mode, in particular with their respective maximum power. As presented above, the respective maximum power here is predefined, or not adjustable. Their maximum possible power can thus be used in the radiant heating device. It can be provided here that in boost mode all of the heating elements of the radiant heating device are connected in parallel. Their power can thus be maximized. In particular, all of the heating elements can be connected to the two outer conductors of a previously-mentioned star-network power supply that comprises at least two outer conductors and one center conductor.

In an advantageous embodiment, a setting of the type of operating mode and of the power of the radiant heating device takes place by means of a rotary switch device, for example with a previously-mentioned energy regulator which can advantageously comprise at least one further additional switch for pure switching functions, that can switch depending on its angle of rotation. Advantageously here, whether the radiant heating device or its heating element is operated in heat maintenance mode, in cooking mode, or in boost mode is precisely and uniquely assigned to each rotary position of the rotary switch device. If appropriate, the power with which the radiant heating device or its heating elements is operated can also be assigned. Advantageously, the power of the radiant heating device or of its heating elements can in cooking mode be adjusted between the minimum cooking power and the maximum cooking power by means of the rotary switch device, depending on the rotary position.

In a possible further embodiment of the invention it can be provided that when turning the rotary switch device, starting from a zero position, in the direction of rising power through a first dead-angle range, power adjustment does not take place, or the power is zero. The dead-angle range can extend from 0° to 30°. In a heat maintenance angular range adjacent thereto, the heat maintenance mode, with the predefined heat maintenance power, can then be set. The heat maintenance angular range can extend from 30° to 60°. In a cooking angular range that is adjacent to or that follows the heat maintenance angular range, in particular from 60° to 280°, the cooking mode and the power of the cooking mode can be adjusted between the minimum cooking power and the maximum cooking power. The cooking angular range can extend from 60° to 280°. The minimum cooking power can correspond to between 100% and 250% of the heat maintenance power. The maximum cooking power can correspond to between 500% and 2000% of the heat maintenance power. In the cooking angular range, the heating element for the heat maintenance mode can be switched off. This also means that it does not have to be connected in such a way that it can be regulated.

In a boost angular range that is adjacent to or that follows the cooking angular range, having an angular range of at least 20°, in particular of up to 40° or 50°, the boost mode can be set. In the boost angular range, the angular range can extend from up to 40° or 50° or be of that size. Here, both the cooking mode can be continued with maximum cooking power, as well as the heating element, not operated in cooking mode, of the radiant heating device operated in heat maintenance mode with heat maintenance power. The boost angular range can advantageously extend from 280° up to at least 300°.

A combination according to the invention of a radiant heating device with a rotary switch device can be designed to carry out the above-described method. The rotary switch device comprises an adjusting rotary switch that is designed for continuous adjustment of a power. It is in particular designed for continuous adjustment of a power in cooking mode. An additional switch is arranged here at the adjusting rotary switch which, in a heat maintenance angular range for the heat maintenance mode as previously described, connects at least one heating element of the radiant heating device to an outer conductor and to a center conductor of the above-mentioned star-network power supply. In a boost angular range for the boost mode, the rotary switch device connects at least this heating element to two outer conductors of the star-network power supply by means of the additional switch.

In one embodiment of the invention at least two heating elements of the radiant heating device can be different in design in the above-mentioned combination. Preferably, all of the heating elements can be of different design. A heating element for the heat maintenance mode can be designed as a heating element with a single, elongated heating conductor, in particular can be designed in accordance with the prior art mentioned at the beginning. A heating element for the cooking mode can be designed as a heating element with a heating conductor that is double or designed with two layers, in particular can be designed in accordance with US 2019/0075620 A1. It can be operated with a very high power for a given length.

These and further features emerge not only from the claims but also from the description and the drawings, wherein the individual features can each be implemented on their own or as a plurality in the form of subsidiary combinations in a form of embodiment of the invention, and implemented for different fields, and can represent embodiments that are advantageous and suitable for protection, for which protection is claimed here. The division of the application into subheadings and individual sections does not restrict the general applicability of the statements made thereunder.

### SHORT DESCRIPTION OF THE DRAWINGS

Further advantages and aspects of the invention emerge from the claims and from the following description of preferred exemplary embodiments of the invention that are explained below with reference to the figures. Here:

FIG. 1 shows a section through a cooktop, shown in simplified form, in which a radiant heating device is combined with a rotary switch device in order to be able to carry out the method,

FIG. 2 shows a plan view of a radiant heating device according to the invention corresponding to FIG. 1,

FIG. 3 shows the illustration of an interconnection of the radiant heating device of FIG. 2 to a star-network power supply and a rotary switch device,

FIGS. 4 to 6 show different interconnections according to the three individual types of operating mode of the heating elements of the radiant heating device,

FIG. 7 shows a division of the angle of rotation and angle of rotation regions of the rotary switch device on which activations of the individual heating elements are shown,

FIG. 8 shows a diagram of the power against the angle of rotation corresponding to the types of operating mode of FIGS. 4 to 6 or according to FIG. 7,

FIG. 9 shows a plan view of a corrugated heating element of double design consisting of two bonded heating conductor strips that have been welded together before the corrugation, and

FIG. 10 shows an alternative design to FIG. 9, with two separately corrugated heating conductive strips that are first laid together after which they are welded.

### DETAILED DESCRIPTION OF THE EXEMPLARY EMBODIMENTS

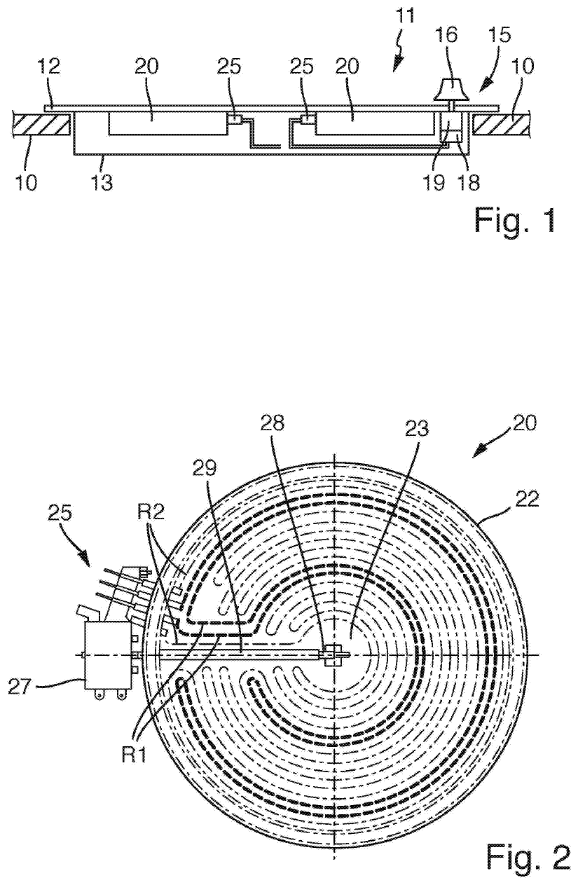

A section through a cooktop 11 in a worktop 10 is illustrated in FIG. 1. The cooktop 11 is in itself designed according to the prior art, with a housing 13 and a cooktop plate 12 on top of that. A rotary switch device 15 is provided, illustrated schematically on the right of the cooktop 11, which forms, with one of the radiant heating devices 20, a combination according to the invention as was described at the beginning. Precisely one such rotary switch device 15 is assigned to each radiant heating device 20. The rotary switch device 15 can also be arranged at a front side instead of above at the cooktop plate 12, as is in itself known from the prior art.

The rotary switch device 15 is also largely designed as is known from the prior art; see the above-mentioned U.S. Pat. No. 9,894,716 B2 or U.S. Pat. No. 6,211,582 B2. It comprises a rotary knob 16 for manual operation, arranged above the cooktop plate 12. An energy regulator 18 and an additional switch 19 are provided, mounted together underneath the cooktop plate 12. The rotary switch device 15 is, as explained in more detail below, designed to operate the radiant heating device 20 with different powers by means of the energy regulator 18 and the additional switch 19 connected thereto, depending on their angle of rotation.

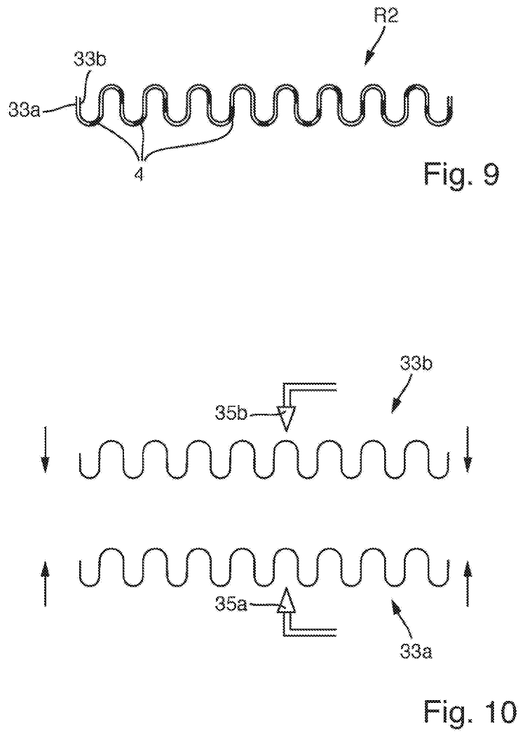

One of the radiant heating devices 20 is illustrated in plan view in FIG. 2. This can here largely correspond to a radiant heating device as is known from the above-mentioned U.S. Pat. No. 9,894,716 B2. The radiant heating device 20 is round in shape and comprises a surrounding housing 22 in which a thermally and electrically insulating carrier 23 extends. The heating elements R1 and R2 are laid in the known manner in loops along concentric circles on the carrier 23. The heating element R1 is illustrated here with heavy dashes and extends, so to speak, along two concentric circular tracks, once with a relatively small radius and once with a relatively large radius. The heating element R2 is designed to be electrically separate therefrom, and extends inside the smaller circular region of the heating element R1 with a very small radius in a plurality of concentric circular tracks, here also adjacent to the heating element R1. The heating element R2 furthermore runs on a circular track outside the larger circle of the heating element R1, and is thus designed to be more strongly or more broadly distributed. While the heating element R1 can be designed as usual, with a usual heating conductor, advantageously corresponding to the above-mentioned U.S. Pat. No. 9,894,716 B2, the heating element R2 can be designed for a higher possible maximum power in a double, or double-layer manner, corresponding to US 2019/0075620 A1. This is explained further in FIGS. 9 and 10 below.

Fastened to the housing 22 on the left, the radiant heating device 20 comprises a connection device 25, entirely as is known from the prior art. The connecting device 25 comprises a number of plug-in connection lugs that go directly to both the terminals of the heating element R1 and to a terminal of the heating element R2. A rod-type thermostat housing 27 is provided for the other electrical terminal at the heating element R2; in the known manner, it comprises an elongated rod-type thermostat 28 that extends into the free region in the center of the carrier 23. A protective tube 29, advantageously of metal or ceramic, is pushed over the major portion of the rod-type thermostat 28. Such a protective tube on a rod-type thermostat is also known from the prior art, and has the purpose of slowing its thermal response time. The rod-type thermostat 28 has the overall purpose of switching off the heating power or of reducing it in the event of excessive temperature on the underside of the cooktop plate 12, which usually consists of glass ceramic, in particular in order to protect the cooktop plate 12. This takes place by means of the switch contact in the rod-type thermostat housing 27, so that, as can be seen, only the heating element R2 can be switched off by the rod-type thermostat 28. This, however, is known from the prior art, in particular from the aforesaid U.S. Pat. No. 9,894,716 B2.

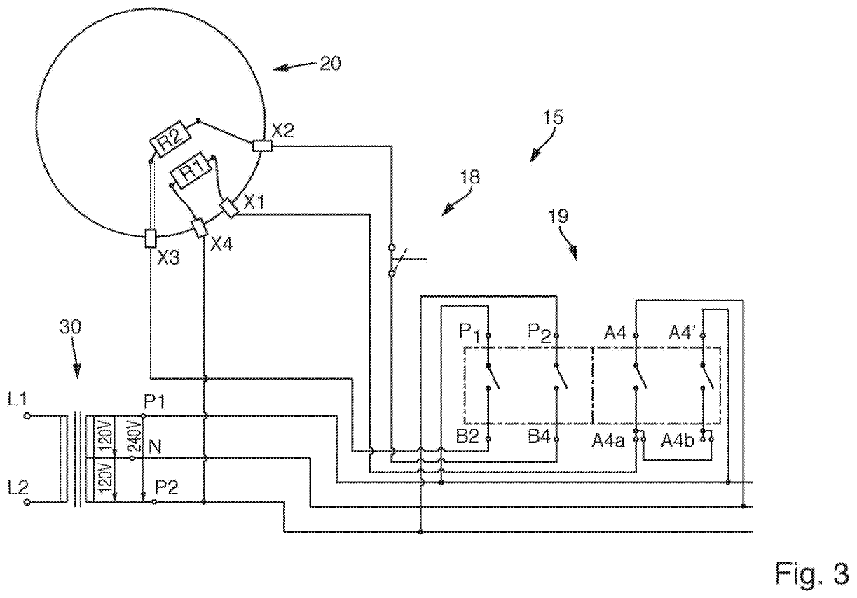

Electrical circuitry of the power supply for the radiant heating device 20 is illustrated in simplified form in FIG. 3. This is illustrated schematically with the two heating elements R1 and R2. The heating element R1 has the terminals X1 and X4 on the outside, while the heating element R2 has the terminals X2 and X3 on the outside. The energy regulator 18 is illustrated in a highly simplified form with a switch in the circuit of the terminal X2 at the heating element R2, in order to be able to disconnect this terminal or in order to be able to precisely adjust and regulate the power of the heating element R2, as explained at the beginning, within a specific range of the angle of rotation of the rotary switch device 15. The rod-type thermostat 28 with its rod-type thermostat housing 27, together with all the switch contacts or switches contained therein, can, for example, also be connected at this terminal branch. For the sake of clarity this is not, however, illustrated here, but can easily be imagined.

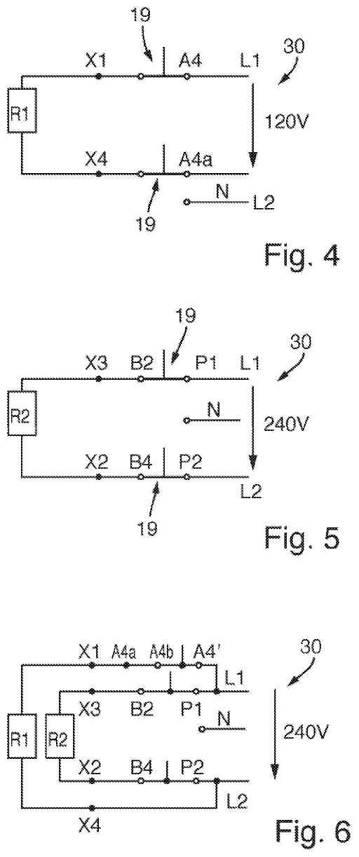

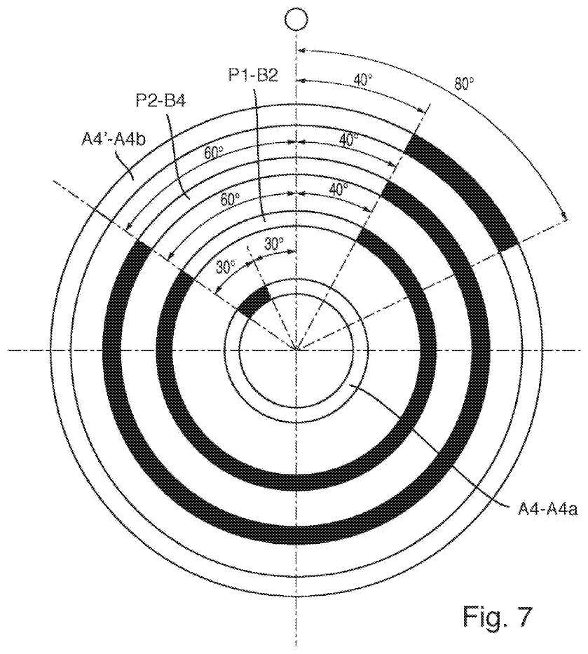

In addition to the energy regulator 18, the rotary switch device 15 also comprises the said additional switch 19. According to FIG. 1 it is mounted on the same rotary shaft, and can be actuated or set by the same rotation as the energy regulator 18 by means of the rotary knob 16. The precise mechanical structure can be derived from the aforesaid prior art. At various angles of rotation, or in various ranges of angular rotation, as are illustrated below in FIG. 7, the four switch contacts or switches illustrated switch in different ways. The switch contacts A4, A4′, A4a and A4b, which can form the plug-in connection lugs or the like, are illustrated. They can be recognized with different interconnections in FIGS. 4 to 6. The additional switch 19 furthermore comprises the terminals P1, P2, B2 and B4. The additional switch 19 is, on the one hand, connected to the heating elements R1 and R2 of the radiant heating device 20, in part by way of the energy regulator 18. It is, furthermore, connected to a star-network power supply 30, which is illustrated here as part of a three-phase connection, as is usually present in a household. This three-phase connection is illustrated here according to the US standard with a star voltage of 120 V between the outer conductors L1 and L2 and a neutral line N. The third conductor is not illustrated, as it is not necessary for this combination. The voltages are each twice as high in Germany. The outer conductor L1 is connected here via the terminal P1 to the switch contact on the far left, which can be connected to the terminal B2, as well as on the far right to the terminal A4′, which can be connected to the terminal A4b. The outer conductor L2 is connected via the terminal P2 to the second switch contact from the left, and can thus be connected to the terminal B4 and the energy regulator 18. It is also connected directly via the terminal X4 to the heating element R1, which can either be connected to the neutral line N or to the first outer conductor L1 via the two right-hand switch contacts and the terminals A4a and A4 or A4b and A4′. With reference to the powers referred to below as well as at the beginning, connection to such a general star-network power supply is always assumed, concretely also having a star voltage of 120 V from the outer conductors to the neutral line, or 240 V between the outer conductors.

The interconnection for heat maintenance mode is illustrated in FIG. 4. Only heating element R1 is operated here, this being done via the second switch contact from the right with the terminals A4 and A4a on the one hand at the outer conductor L1, and on the other hand to the neutral line N. The heating element R1 is thus operated with a voltage of 120 V for heat maintenance mode. This results in a relatively low power which, due to the dimensioning of the heating element R1, can lie at around 275 W. As a result of the distributed arrangement of the heating element R1 according to FIG. 2, it can be seen that in the region covered thereby, a moderately distributed generation of the heating power can take place, which can be thought of as very advantageous for heat maintenance mode. Since both the power per unit area and the absolute power are very low, it is not necessary for the temperature to be monitored by the rod-type thermostat 27/28.

In the representation of the ranges of angular rotation according to FIG. 7, starting from the vertical line and moving upwards in an anticlockwise direction, the hatching of the circular track between an angle of 30° to 60°, i.e. over a range of angular rotation of 30°, it can be seen that this switch state is present with appropriate rotation at the rotary switch device 15. This means that after turning the rotary knob 16 through 30° nothing yet happens, and then for an angular range of a further 30° the heat maintenance mode by means of the heating element R1 occurs with the aforesaid power. The other heating element R2 is not operated.

If the rotary knob 16 is turned further, the switch contact at the terminals A4 and A4a for the heating element R1 opens again, directly after which the switch contact at the terminals P1 and B2 as well as at P2 and B4 are closed. This remains true over a range of angles of rotation from 260° to 320°. As can be seen from FIG. 5, the heating element R2 is connected here by means of the terminals X3 to the terminals B4 and P2 and to the outer conductor L2. The terminal X3 is connected via the energy regulator 18 at the terminals B2 and P1 to the outer conductor L1 through the connecting contact connected in between. The energy regulator 18 is provided in between the terminals B4 and X2. If it is closed, the heating element R2 is operated with the outer conductor voltage of 240 V, i.e. at its maximum voltage.

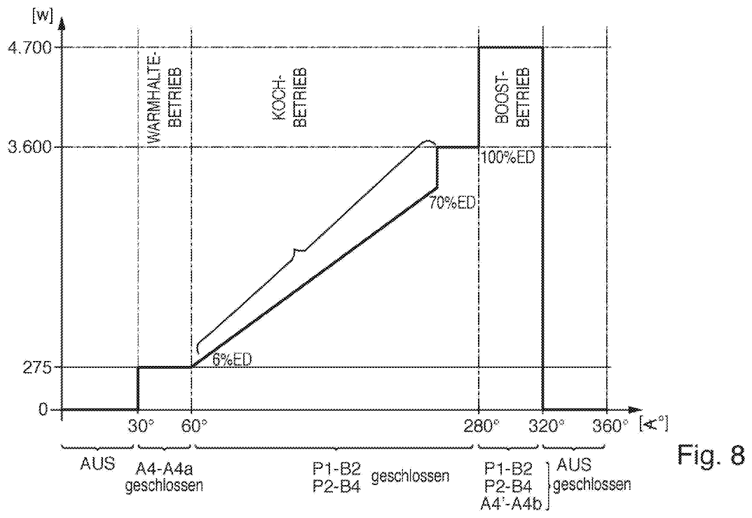

Through the clocking of the energy regulator, not illustrated here, depending on the angular setting in the said range of angles between 60° and 320°, a switched-on duration ED is changed, as is known from the prior art. This defines the ratio between the time during which the energy regulator 18 is closed and the time during which the energy regulator 18 is open. It can be seen that according to the diagram of the power of the radiant heating device 20 over the angular range according to FIG. 8, that following the power of 275 W by means of the heating element R1, which is generated at a constant rate over a particular angular range, the power of the heating element R2 rises in cooking mode. It rises here from 6% ED corresponding to the 275 W at an angle of rotation of 60° up to a power of about 2500 W at an angle of rotation of about 250°, corresponding to 70% ED. The power enabled by the energy regulator 18 then, so to speak, makes a jump up to 100% ED, corresponding to 3600 W up to an angle of rotation of 280°. The heating element R2 is thus operated continuously at the outer conductor voltage of 240 V corresponding to FIG. 5, and is so designed that in this continuous operation it generates the said 3600 W. Switching off here is now only provided by means of the rod-type thermostat 28, although this does not actually play a role in the context of the present application.

If now, for example in order to bring a large quantity of water in a large pot to the boil, a power is generated that is even beyond the maximum cooking power of 3600 W, the heating element R1 is also connected. The heating element R2 is, after all, already at its power limit. The heating element R1 is, however, not connected in as is provided for in heat maintenance mode, namely across the star voltage, but also across the outer conductor voltage. This is illustrated in FIG. 6. The switch contact between the terminals A4 and A4a is open for this purpose, while the switch contact between the terminals A4′ and A4b on the far right is closed. The heating element R1 is thus also connected to the outer conductors L1 and L2, i.e. to a voltage of 240 V. As a result of the double voltage, the heating element R2 in boost mode can thus generate four times as much power as in heat maintenance mode. A maximum total power, or boost power, of 4700 W therefore results. This boost power is reached in boost mode according to FIG. 7 over an angle of rotation of between 280° and 320°, i.e. over a range of angular rotation of 40°. The remaining 40° of the angle of rotation, i.e. in the range of angular rotation from 320° to 360° do not have any connecting function. The zero position at an angle of rotation of 0° can thus be cleanly maintained without malfunction.

In boost mode, the energy regulator 18 is advantageously always closed. An interruption of the supply of power to the radiant heating device 20 can only be provided by the rod-type thermostat 28 or its rod-type thermostat housing 27, for example because a temperature at the underside of the cooktop plate 12 is too high.

So that the heating element R2 can achieve the said very high power of 3600 W with a predefined installed length or total length according to FIG. 2, it is advantageously provided that it is designed as the double heating conductor mentioned at the beginning. In this way a significantly higher power can be generated with the same length as in the past. It can easily be imagined that the radiant heating device 20 cannot be operated for a very long time in boost mode. A maximum duration can here be less than five minutes, advantageously less than two minutes or even less than one minute. This can simply be limited by the switching of the rod-type thermostat 28 at too high a temperature. This can be affected through concrete design measures, in particular through the design of the protective tube 29 over the rod-type thermostat 28.

A further advantage of the invention lies in that the different types of operating mode, as well as the regulated power in cooking mode, when they are deemed necessary, are achieved or set in a purely electromechanical manner. Complex relay controllers or microcontrollers or the like are not necessary. Advantageously, the entire control of the radiant heating device is electromechanical; the cooktop provided therewith is designed without a microcontroller for setting the power of the radiant heating device, i.e. purely electromechanically.

In the plan view of a double, or double-layer, heating element R2 in FIG. 9 it is possible to see what state it is in after the corrugations, i.e. when corrugation of the heating element R2 has been completed. The heating element R2 manufactured as described above in two layers from the two strip-shaped heating conductors 33a and 33b has passed through a device for corrugation, as is already used in the prior art for the manufacture of corrugated heating elements known from the documents referred to at the beginning. The locations of the welds 34 along the corrugation, i.e. whether they are at apexes or at inflection points of the wave shape, does not play a role for the finished heating element R2. This double-layer heating element R2 can thus generate significantly greater heating powers.

In an alternative method for the manufacture of a heating element for a heating device 11, the individual strip-shaped heating conductors 33a and 33b are first corrugated according to FIG. 10. A shape of this corrugation can, in principle, correspond to that of FIG. 9, and can be done as is known in the prior art. The two corrugated heating conductors 33a and 33b are then placed on top of one another, advantageously in such a way that fixing members not illustrated here either lie precisely on top of one another or are offset with respect to one another. The welds are then made by means of welding tips 35a and 35b in the manner previously described, in order to bond the two heating conductors 33a and 33b to one another firmly and non-releasably.

Thus in the method illustrated in FIG. 10, the still separate heating conductors 33a and 33b are first corrugated, then put together or placed on top of one another, after which they are firmly and non-releasably bonded together. This has the advantage that a corrugation of the heating conductors can be expected to be easier, since it corresponds precisely to the procedure of the prior art. The relatively difficult performance of the subsequent welding, even with relatively thin welding tips, is however disadvantageous. These must, after all, ideally perform the welding at the tops of the corrugation, i.e. at the apexes, since pressing the heating conductors together is most easily possible here. It is, however, to be expected that this is not always easy to do.

1. A method for operation of a radiant heating device for a cooktop, wherein said radiant heating device comprises at least two separately operable heating elements being arranged in loops or in spirals and/or being arranged essentially along concentric circles on a carrier of said radiant heating device, wherein said separately operable heating elements are individually connectable to a power supply,
wherein said method comprises a heat maintenance mode, a cooking mode and a boost mode with said radiant heating device,
wherein in said heat maintenance mode, not all said heating elements are operated, but one said heating element with a single, fixed, relatively low heat maintenance power is operated,
wherein in said cooking mode, one said heating element is operated with adjustable power, wherein said adjustable power of said one operated heating element is adjusted between a relatively low minimum cooking power and a relatively high maximum cooking power,
wherein in said boost mode, all said heating elements of said radiant heating device are operated, wherein said power of all said heating elements is fixed and not adjustable, wherein in said boost mode said at least one heating element operated in said cooking mode, or all of said heating elements operated in said cooking mode, are operated with their maximum power in said cooking mode, and said at least one, or all of, said heating elements that are not operated in said cooking mode are operated with at least said heat maintenance power of said heat maintenance mode.

2. The method as claimed in claim 1, wherein said heating elements in said heat maintenance mode are different from said heating elements in said cooking mode, wherein no said heating element is operated in said heat maintenance mode and also in said cooking mode.

3. The method as claimed in claim 1, wherein in said heat maintenance mode, said at least one heating element operated in said heat maintenance mode is connected to an outer conductor and to a center conductor of a star-network power supply that comprises at least two said outer conductors and one said center conductor.

4. The method as claimed in claim 1, wherein in said heat maintenance mode, only one single said heating element is operated.

5. The method as claimed in claim 4, wherein said single heating element is operated in said heat maintenance mode with a lowest possible power of operation of said radiant heating device.

6. The method as claimed in claim 1, wherein said relatively low minimum cooking power and said relatively high maximum cooking power are between 4% and 90% of said maximum power of said radiant heating device or are between 200 W and 4000 W.

7. The method as claimed in claim 1, wherein in said cooking mode, said at least one heating element operated in said cooking mode is connected to two outer conductors of a star-network power supply that comprises at least two said outer conductors and one said center conductor.

8. The method as claimed in claim 7, wherein in said cooking mode only one single heating element is operated.

9. The method as claimed in claim 8, wherein said one single heating element being operated in said cooking mode is not said heating element that is operated in said heat maintenance mode.

10. The method as claimed in claim 7, wherein in said cooking mode a total power generated by said radiant heating device is adjustable.

11. The method as claimed in claim 10, wherein in said cooking mode said total power generated by said radiant heating device is adjustable through clocking by means of an actuation duration.

12. The method as claimed in claim 1, wherein a power of said radiant heating device is only adjustable in said cooking mode, wherein in said heat maintenance mode and in said boost mode said power of said radiant heating device or of said heating elements is in each case predefined.

13. The method as claimed in claim 1, wherein in said boost mode all said heating elements of said radiant heating device are operated, wherein said respective maximum power is predefined or is not adjustable.

14. The method as claimed in claim 13, wherein in said boost mode all said heating elements of said radiant heating device are operated with said maximum power in each case.

15. The method as claimed in claim 13, wherein in said boost mode all of said heating elements of said radiant heating device are connected in parallel.

16. The method as claimed in claim 1, wherein a setting of a type of operating mode and of said power of said radiant heating device takes place by means of a rotary switch device with several rotary positions, wherein whether said radiant heating device or its said heating element is operated in said heat maintenance mode, in said cooking mode or in said boost mode, and possibly also said power with which it is operated, is precisely and uniquely assigned to each said rotary position.

17. The method as claimed in claim 16, wherein said power of said radiant heating device or of its said heating elements in said cooking mode is adjustable between a minimum cooking power and a maximum cooking power by means of said rotary switch device, depending on said rotary position.

18. The method as claimed in claim 16, wherein when turning said rotary switch device starting from a zero position in a direction of rising power through a first dead-angle range, power adjustment does not take place or said power is zero, wherein in a heat maintenance angular range adjacent thereto, said heat maintenance mode, with a predefined heat maintenance power, can then be set,
wherein in a cooking angular range that is adjacent to or that follows said heat maintenance angular range, said cooking mode and said power of said cooking mode can be adjusted between a minimum cooking power, and a maximum cooking power,
wherein, in said cooking angular range, said heating element for said heat maintenance mode is switched off,
wherein in a boost angular range that is adjacent to or that follows said cooking angular range, having an angular range of at least 20°, said boost mode can be set, wherein both said cooking mode can be continued with maximum cooking power, as well as said heating element, not operated in cooking mode, of said radiant heating device operated in said heat maintenance mode with heat maintenance power.

19. A combination of a radiant heating device with a rotary switch device, wherein said combination is designed to carry out said method as claimed in claim 1, wherein said rotary switch device comprises an adjusting rotary switch that is designed for continuous adjustment of a power, wherein an additional switch is arranged at said adjusting rotary switch which, for said heat maintenance mode, connects, in a heat maintenance angular range, at least one heating element of said radiant heating device to an outer conductor and to a center conductor of a star-network power supply, and which in a boost angular range, for said boost mode, connects at least said heating element to two outer conductors of said star-network power supply.

20. The combination as claimed in claim 19, wherein at least two said heating elements of said radiant heating device are of different design.

21. The combination as claimed in claim 20, wherein one said heating element for said heat maintenance mode is designed as a heating element with a single, elongated heating conductor, and wherein a heating element for said cooking mode is designed as a heating element with a heating conductor that is double or is designed with two layers.
